(19) United States
(12) Patent Application Publication
(10) Pub. No.: US 2021/0037544 A1
(43) Pub. Date: Feb. 4, 2021

(54) NETWORK SLICING BASED ON ONE OR MORE TOKEN COUNTERS

(71) Applicant: Nokia Solutions and Networks Oy, Espoo (FI)

(72) Inventors: Daniel Andrews, Chatham, NJ (US); Silvio Mandelli, Tamm (DE); Simon Borst, Maplewood, NJ (US)

(21) Appl. No.: 17/041,195

(22) PCT Filed: Mar. 27, 2018
(86) PCT No.: PCT/EP2018/057827

§ 371 Date: Sep. 24, 2020

(51) Int. Cl. H04W 72/12

(52) U.S. Cl. CPC H04W 72/1205; H04W 72/1257

(57) ABSTRACT

Wireless transmissions via a wireless network may be improved by using network slice tokens. One or more user devices may be assigned to a network slice or several network slices, and a computing device may determine whether transmissions via the network slice satisfy target(s). Based on whether the target(s) are satisfied, a token counter value associated with the network slice may be adjusted. A weight associated with each flow or user may be determined based on the token counter value. A computing device may allocate transmission resources to the flow or user based on the weight.

### BACKGROUND

A network may be sliced into multiple network slices. Data may be wirelessly transmitted to user devices via those network slices, such as over a common underlying physical infrastructure. Different parameters for each network slice may be used to meet different needs of the network slices.

### BRIEF SUMMARY

This summary is provided to introduce a selection of concepts in a simplified form that are further described below in the Detailed Description. This Summary is not intended to identify key features or essential features of the various embodiments, nor is it intended to be used to limit the scope of the claims.

One or more user devices may be assigned to a network slice of a plurality of network slices. A computing device may determine whether transmissions via a network slice satisfy a target. Based on determining whether transmissions via the network slice satisfy the target, the computing device may adjust a token counter value associated with the network slice. Adjusting the token counter value may be based on a previous token counter value associated with the network slice. Based on the adjusted token counter value, a weight associated with the user device may be determined. The computing device may allocate, to the user device and/or based on the weight associated with the user device, transmission resources. One or more network packets may be transmitted to the user device, using the allocated transmission resources.

In some examples, determining whether transmissions via the network slice satisfy the target may comprise determining that transmissions via the network slice satisfy the target. Adjusting the token counter value associated with the network slice may comprise decreasing the token counter value associated with the network slice or increasing the token counter value associated with the network slice. Decreasing the token counter value associated with the network slice may comprise decreasing the token counter value to a predetermined low token counter value. Increasing the token counter value associated with the network slice may comprise increasing the token counter value to a predetermined high token counter value.

In some examples, one or more scheduling parameters may be received from, for example, a service data adaptation protocol (SDAP) layer. Determining the weight associated with the user device may comprise determining, based on the scheduling parameter received from the SDAP layer, the weight associated with the user device.

In some examples, determining whether transmissions via the network slice satisfy the target may comprise determining that transmissions via the network slice do not satisfy the target. Adjusting the token counter value associated with the network slice may comprise increasing the token counter value associated with the network slice or decreasing the token counter value associated with the network slice. Increasing the token counter value associated with the network slice may comprise increasing the token counter value to a predetermined high token counter value. Decreasing the token counter value associated with the network slice may comprise decreasing the token counter value to a predetermined low token counter value. Based on a determination that a plurality of token counter values associated with the network slice match the high predetermined token counter value at least a threshold number of times or a determination that a plurality of token counter values associated with the network slice match the predetermined low token counter value at least a threshold number of times, a performance parameter associated with the network slice may be adjusted.

In some examples, a second user device may be assigned to a second network slice of the plurality of network slices. The computing device may determine whether transmissions via the second network slice satisfy a second target. Based on determining whether transmissions via the second network slice satisfy the second target, the computing device may adjust a second token counter value associated with the second network slice. Based on the adjusted second token counter value, a second weight associated with the second user device may be determined. The computing device may allocate, to the second user device and based on the second weight associated with the second user device, transmission resources.

In some examples, the computing device may determine a priority level associated with the user device. Determining the weight associated with the user device may comprise determining, based on the priority level associated with the user device, the weight associated with the user device. Additionally or alternatively, determining the weight associated with the user device may comprise determining, based on a proportional fairness metric, the weight associated with the user device.

In some examples, the computing device may comprise a base station. The base station may comprise a medium access control (MAC) scheduler for adjusting the token counter value.

In some examples, assigning the user device to the network slice may comprise assigning the user device to a plurality of flows. Each flow of the plurality of flows may comprise a different type of flow. A first flow of the plurality of flows may comprise a mobile broadband flow. A second flow of the plurality of flows may comprise an ultra-reliable low-latency communication flow. The target may comprise one or more of a bitrate target, a throughput target, a latency target, or a resource share target. Other aspects are discussed further below.

### BRIEF DESCRIPTION OF THE DRAWINGS

Some example embodiments are illustrated by way of example and not limited in the accompanying figures in which like reference numerals indicate similar elements and in which:

FIG. 1 is a block diagram of an example communication system in which one or more embodiments may be implemented.

FIG. 2 illustrates an example of changing transmission rates with no slice constraints according to one or more embodiments described herein.

FIG. 3 illustrates an example of changing transmission rates when a slice has a minimum bitrate constraint according to one or more embodiments described herein.

FIG. 4 illustrates an example of changing transmission rates when two slices have minimum bitrate constraints according to one or more embodiments described herein.

FIG. 5 illustrates an exemplary slicing control scheme according to one or more embodiments described herein.

FIG. 6 illustrates an example of adjusting one or more token counters according to one or more embodiments described herein.

FIG. 7 illustrates another example of adjusting one or more token counters according to one or more embodiments described herein.

FIG. 8 illustrates yet another example of adjusting one or more token counters according to one or more embodiments described herein.

FIG. 9 illustrates an exemplary method of adjusting network slices according to one or more embodiments described herein.

FIG. 10 is a block diagram of an example communication device according to one or more embodiments described herein.

### DETAILED DESCRIPTION

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

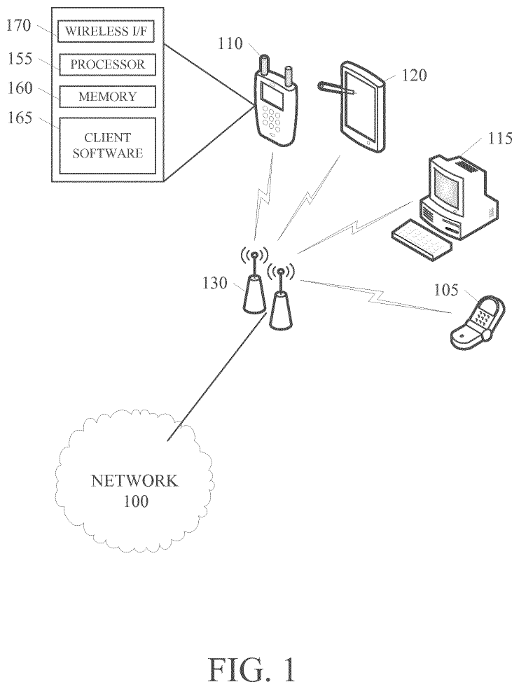

FIG. 1 illustrates an example of a system for network slicing through which various embodiments may be practiced. As seen in FIG. 1, the system may include an access node (e.g., access point (AP)) 130 and a number of wireless stations (STAs) 105, 110, 115, and 120. Orthogonal frequency division multiplexing access (OFDMA) may be used in a system for multiplexing wireless devices for uplink and/or downlink data transmissions. In OFDMA systems, a frequency spectrum is divided into a plurality of closely spaced narrowband orthogonal subcarriers. The subcarriers are then divided into mutually exclusive groups called subbands, with each subband (also referred to as subchannels) assigned to one wireless device or multiple wireless devices. According to various aspects, subcarriers may be assigned to different wireless devices. OFDMA has been adopted in synchronous and cellular systems, including 4G broadband wireless standards (e.g. Long-Term Evolution (LTE)), 5G wireless standards (e.g., New Radio (NR)), and IEEE 802.16 family standards.

In FIG. 1, the STAs may include, for example, a mobile communication device 105, mobile phone 110, personal digital assistant (PDA) or mobile computer 120, computer work station (for example, personal computer (PC)) 115, or other portable or stationary device having a wireless interface capable of communicating with an access node (e.g., access point) 130. The STAs in the system may communicate with a network 100 or with one another through the AP 130. Network 100 may include wired and wireless connections and network elements, and connections over the networks may include permanent or temporary connections. Communication through the AP 130 is not limited to the illustrated devices and may include additional mobile or fixed devices. Such additional mobile or fixed devices may include a video storage system, an audio/video player, a digital camera/camcorder, a positioning device such as a GPS (Global Positioning System) device or satellite, a television, an audio/video player, a tablet computer, a radio broadcasting receiver, a set-top box (STB), a digital video recorder, a video game console, a remote control device, a vehicle, and the like.

While one AP 130 is shown in FIG. 1, the STAs may communicate with multiple APs 130 connected to the same network 100 or multiple networks 100. Also, while shown as a single network in FIG. 1 for simplicity, network 100 may include multiple networks that are interlinked so as to provide internetworked communications. Such networks may include one or more private or public packet-switched networks, for example the Internet, one or more private or public circuit-switched networks, for example a public switched telephone network, a satellite network, one or more wireless local area networks (e.g., 802.11 networks), one or more metropolitan area networks (e.g., 802.16 networks), and/or one or more cellular networks configured to facilitate communications to and from the STAs through one or more APs 130. In various embodiments, an STA may perform the functions of an AP for other STAs.

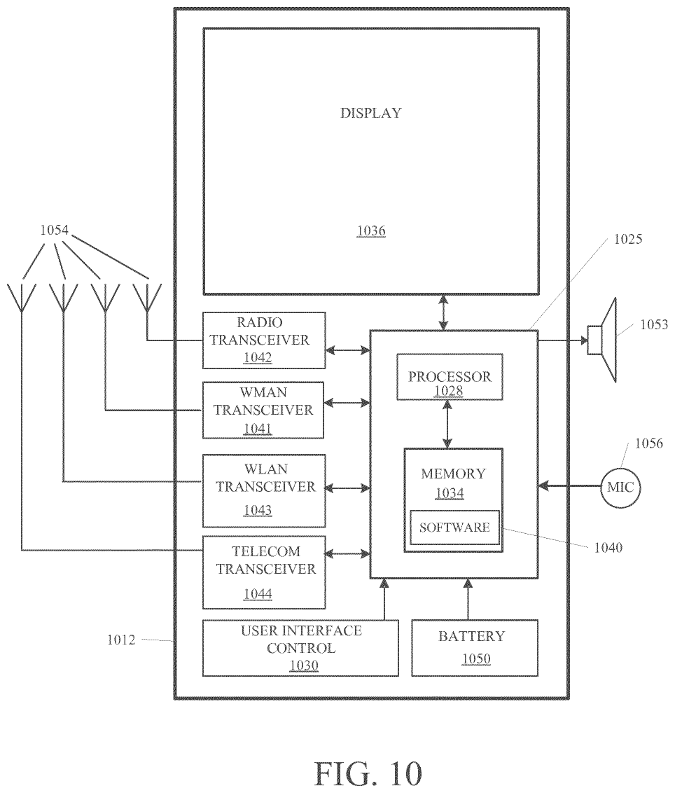

Communication between the AP and the STAs may include uplink transmissions (e.g., transmissions from an STA to the AP) and downlink transmissions (e.g., transmissions from the AP to one or more of the STAs). Uplink and downlink transmissions may utilize the same protocols or may utilize different protocols. For example, in various embodiments STAs 105, 110, 115, and 120 may include software 165 that is configured to coordinate the transmission and reception of information to and from other devices through AP 130 and/or network 100. In one arrangement, client software 165 may include specific protocols for requesting and receiving content through the wireless network. Client software 165 may be stored in computer-readable memory 160 such as read only, random access memory, writeable and rewriteable media and removable media and may include instructions that cause one or more components—for example, processor 155, wireless interface (I/F) 170, and/or a display—of the STAs to perform various functions and methods including those described herein. AP 130 may include similar software 165, memory 160, processor 155 and wireless interface 170 as the STAs. Further embodiments of STAs 105, 110, 115, and 120 and AP 130 are described below with reference to FIG. 10.

Any of the method steps, operations, procedures or functions described herein may be implemented using one or more processors and/or one or more memory in combination with machine executable instructions that cause the processors and other components to perform the method steps, procedures or functions. For example, as further described below, STAs (e.g., devices 105, 110, 115, and 120) and AP 130 may each include one or more processors and/or one or more memory in combination with executable instructions that cause each device/system to perform operations as described herein.

One or more algorithms for sharing resources among a plurality of network slices is described herein. The algorithms (or portions thereof) may be performed by a scheduler, such as a medium access control (MAC) scheduler. Algorithm(s) described herein may improve access networks, such as radio access networks (e.g., RANs, such as 4G LTE access networks, 5G access networks, etc.). The algorithm(s) may improve an aggregate utility metric (e.g., proportional fair for best-effort flows), while satisfying heterogeneous (and possibly overlapping) throughput or resource constraints or guarantees. The algorithm(s) may offset the nominal proportional fair scheduling weight by additive terms, making it transparent to other modules of the scheduler (e.g., the MU-MIMO beam-forming functionality), except the module that performs, for example, a weight computation. The algorithms may be used to improve mobile broadband (MBB) full-buffer traffic conditions and/or ultra-reliable low-latency communication (URLLC) traffic conditions.

A network (or portions thereof) may be sliced into a plurality of virtual networks, which may run on the same physical infrastructure (e.g., an underlying physical 4G or 5G infrastructure). Each virtual network may be customized for the user(s) and/or group(s) in the virtual network. One or more users may be grouped into the same network slice. Each user in the same slice may be in a good channel condition, a bad channel condition, or other channel condition. Network slicing in a mobile network may allow a wireless network operator to assign portions of the capacity to a specific tenant or traffic class. Examples of a network slice may be, for example, traffic associated with an operator (e.g., a mobile virtual network operator (MVNO)), traffic associated with an enterprise customer, URLLC traffic, MBB traffic, verticals (e.g., for automotive applications), or other types of traffic. Network slices may have different statistical characteristics and/or different performance, quality of experience (QoE), and/or quality of service (QoS) requirements. A slice may comprise a plurality of flows. Performance or service guarantees for various slices may be defined in terms of aggregate throughput guarantees (e.g., greater than 100 megabits per second (Mbps) or less than 200 Mbps), guaranteed resource shares (e.g., greater than or less than 25% of capacity), and/or latency bounds, such as for sets of flows or users or longer time intervals (e.g., 500 ms, 500 time slots, 1000 ms, 1000 time slots, etc.). Resources on a slot-by-slot transmission time interval (TTI) basis may be allocated to individual flows.

URLLC traffic flows in 5G systems may have low latency requirements, such as end-to-end latencies in the single or double digit milliseconds and/or physical layer latencies in the 0.5 millisecond range. URLLC traffic flows in 5G systems may also have high reliability requirements, such as block error rates (BLERs) less than 10⁻⁵. Packet sizes in 5G URLLC flows may also be smaller (e.g., tens or hundreds of bytes in size). MBB traffic flows, on the other hand, may have different characteristics from URLLC traffic flows. Packet sizes for MBB traffic flows may be larger than packet sizes for URLLC traffic flows. For example, packet sizes for MBB traffic flows may be on the order of greater than 100 bytes. MBB traffic flows may also support higher throughput (e.g., peak throughput) or bandwidth requirements than URLLC traffic flows, in some circumstances. Latencies for MBB traffic flows (e.g., on the order of 4 milliseconds for physical layer latencies) may also be higher than latencies for URLLC traffic flows.

An operator may assign high-level performance parameters, such as slicing constraints, for each network slice or traffic class. These high-level performance requirements may be achieved through MAC resource allocation decisions, such as by a MAC scheduler, at the per-transmission time interval (TTI) granularity. Service differentiation may in be terms of key performance indicators (KPIs) and/or service level agreements (SLAs).

An operator may translate application-level requirements for the flows in a slice into the high-level slice performance parameters using a quality of experience (QoE) scheduler in an access stratum sublayer that maps flows to radio bearers (e.g., data radio bearers (DRBs)) and which specifies the quality of service (QoS) parameters for each DRB. Radio bearers, such as DRBs, may carry, for example, user data to and/or from user equipment (UEs)/STAs. A flow, such as a QoS flow, may comprise a guaranteed bit rate (GBR) flow or a non-GBR flow. A DRB may comprise a flow, or a DRB may comprise multiple flows.

A scheduler may support multiple types of slicing constraints. For example, the scheduler may meet slicing constraints by applying modifications to scheduling weights used as metrics in proportional fair schedulers or other types of schedulers.

An exemplary scheduling framework will now be described. Assume a scheduler manages a set of flows, e.g., I={1, . . . , M}. The scheduler may assign these flows to a set of time slot/frequency pairs, which may be indexed by (τ, λ). At each time τ, there may be a flow weight Wᵢ(τ) that indicates the relative priority weight to be given to flow i when allocating resources. This flow weight might not include components that are directly based on the channel condition at time τ. Consider a set of flows Π⊆I that may be a candidate for scheduling on (τ, λ). Multiple flows may be scheduled on a single time slot/frequency pair, such as if multi-user multiple-input multiple-output (MU-MIMO) is enabled. Let c_{i,Π,τ,λ} be the amount of data served from flow i when the set Π is scheduled, for example, c_{i,Π,τ,λ}=0 if i∉Π. In full-buffer conditions, the scheduler may aim to choose the set Π for (τ, λ) so as to maximize:

$${\sum }_{i ∈ Π} {W}_{i} ( τ ) {c}_{i , Π , τ , λ} .$$

Let Sᵢ (τ) correspond to the total amount of data served from flow i at time τ and/or the rate (e.g., number of data bits transmitted in time slot τ) provided to flow i and/or user i in time slot τ. Let Rᵢ (τ) be the corresponding exponentially smoothed rate and/or smoothed throughput of flow i and/or user i over a time scale of the order 1/δ. For example, Rᵢ(τ) may be recursively updated in time slot τ as Rᵢ(τ+1)=(1−δ) Rᵢ (τ)+δ Sᵢ (τ) for some parameter δ, which may comprise a small positive parameter (e.g., δ∈[0, 1]). Rᵢ (τ) may be used to track, for example the rate and/or throughput for a flow and/or user over time. Sᵢ (τ) may correspond to the product of the channel rate for the modulation and coding scheme (MCS) that is assigned to flow i and the amount of resources assigned to it. For a proportional fair rate objective, whose goal may be fairness by maximizing:

ΣᵢU_{PF}(Rᵢ)=Σᵢ log(Rᵢ),

without slicing constraints, the flow weight may be

Wᵢ(τ)=U′_{PF}(Rᵢ(τ))=1/Rᵢ(τ)

On the other hand, to maximize aggregate throughput

ΣᵢU_{MT}(Rᵢ(τ))=ΣᵢRᵢ,

Wᵢ(τ)=U′_{MT}(Rᵢ(τ))=1

may be used to achieve that goal. A γ-fair utility function

ΣᵢU_{γ}(Rᵢ(τ))=ΣᵢRᵢ(τ)^{1-γ}/(1−γ) (for γ≠1)

via the weights Wᵢ(τ)=U′_{γ}(Rᵢ(τ))=(Rᵢ(τ))^{-γ} may be used. The algorithm to implement the slicing constraints may be independent of the choice of a proportional fairness (PF) function, a maximum throughput (MT) function, a γ-fair function, or any other function.

In full-buffer conditions, the frequency-by-frequency maximization described above may imply maximization of

$${\sum }_{i = 1}^{M} {W}_{i} ( τ ) {S}_{i} ( τ ) ..$$

Even in non-full-buffer scenarios, the goal may be to maximize the above overall weighted sum rate, subject to the constraint that Sᵢ(τ) does not exceed the buffer content Qᵢ(τ) of flow i at time τ, but the overall maximization might not be easily broken down in per frequency maximization problems.

Exemplary slices will now be described. Each slice j may comprise a set of coefficients αᵢⱼ and a performance target βⱼ. αᵢⱼ may indicate whether or not the i-th flow and/or user is included in the j-th slice. βⱼ may indicate, for example, an aggregate throughput target for the j-th slice. The slice constraint for slice j and at the time slots τ may take the form:

$${\sum }_{i = 1}^{N} {α}_{i j} {R}_{i} ( τ ) N \geq {β}_{j} . \qquad ( a )$$

The above constraint may capture either lower or upper bounds on weighted rate sums, depending on whether the αᵢⱼ and βⱼ values are positive or negative. There may be a special case in which each slice j is defined in terms of a set of flows Kⱼ⊆I, αᵢⱼ=1 if i∈Kⱼ, and αᵢⱼ=0 otherwise. Moreover, a slice constraint may be defined in terms of the average amount of resources assigned to flow i, rather than the average rate. A similar algorithm may apply, but for simplicity, the above case of maintaining either a lower or upper bound on the aggregate rate received by flows in the slice will be described.

In some examples, latency constraints for the flows within a slice may also be used. However, since latency may be a per-flow metric, such constraints may be supported by treating each flow as a URLLC-type flow with a latency bound. The above formulation may be flexible in that slices may comprise overlapping set of flows with heterogeneous throughput constraints. In particular, the formulation may support cases in which there are individual QoS constraints for flows within a slice. A separate slice for each such flow may be defined, and the QoS parameters for the flow may translate into QoS parameters for that slice.

Slice constraints may be implemented by modifying flow weights Wᵢ(τ) to depend on one or more token counters. An advantage of changing Wᵢ(τ) may be that methods for defining the values may be combined. These techniques may be applied to MU-MIMO, SU-MIMO, hybrid or digital beamforming, etc. One or more token counters may be associated with a slice (e.g., GBR, minimum resources, and/or latency slices). The token counter(s) may be used to track what degree of performance or service target the slice is achieving. Token counter(s) (τ)ⱼ(τ) may be used to change the value of the scheduling weights Wᵢ(τ). A token counter Tⱼ(τ), such as for a GBR token counter, may be updated in time slot τ based on:

$${T}_{j} ( τ + 1 ) = max \{ {T}_{j} ( τ ) + {β}_{j} - {\sum }_{i} {α}_{i j} {S}_{i} ( τ ) , 0 \} .$$

The token counter Tⱼ(τ+1) may be adjusted based on the value of the previous token counter Tⱼ(τ) and/or the value of a performance target βⱼ (e.g., an aggregate throughput target) for the j-th slice. The token counter Tⱼ(τ+1) may also be adjusted based on the value of a sum (e.g., for each user i) of a product of a coefficient αᵢⱼ and Sᵢ (τ) (e.g., a total amount of data served from flow i at time τ and/or the rate provided to user i in time slot τ). The token counter may measure how much the j-th slice constraint is or is not met at the time τ. The scheduler may use the token counter to monitor the performance of the slice relative to its constraint(s). If the constraint(s) are satisfied, the token counter Tⱼ(τ+1) may be decreased relative to the previous token counter Tⱼ(τ). If the constraint(s) are not satisfied, the token counter Tⱼ(τ+1) may be increased relative to the previous token counter Tⱼ(τ). In some examples, the token counter Tⱼ(τ+1) may be capped at a maximum value Tₘₐₓ. If the constraint cannot be satisfied for an extended period (e.g., X seconds), such as if the cap is frequently applied, the slice parameters may be renegotiated or admission control/overload control (AC/OC) procedures may be triggered.

For best-effort flows (e.g., MBB flows), the weight may be set as:

$${W}_{i} ( τ ) = {U}_{P F}^{′} ( {R}_{i} ( τ ) ) + δ {\sum }_{j = 1}^{N} {α}_{i j} {T}_{j} ( τ ) = \frac{1}{{R}_{i} ( τ )} + δ {\sum }_{j = 1}^{N} {α}_{i j} {T}_{j} ( τ ) , \qquad ( 1 )$$

The first term may correspond to the proportional fair rate objective, and N may be the number of slices. The complexity in computing the sum in the above equation may depend on the number of slicing constraints related to flow i. In the case of one constraint, it may involve an addition of a single term equal for flows (e.g., all flows) belonging to that slice. For higher-priority and latency-sensitive flows (e.g., URLLC flows), some notion of dynamic or static priority may be included, and the weight for such flows may be of the form:

$${W}_{i} ( τ ) = {Δ}_{i} + δ {\sum }_{j = 1}^{N} {α}_{i j} {T}_{j} ( τ ) , \qquad ( 2 )$$

Δi may be a constant positive offset which captures the priority level of flow i. In equation (2), the priority flow's weight may correspond to a prioritized maximum aggregated throughput solution. Fairness for these flows may also be inserted, such as to prevent starvation in a burst of high priority traffic. For example, a term proportional to (Rᵢ(τ))^{-γ} may be added.

A scheduling algorithm, e.g., working with weights given by equations (1) and (2), may be compatible with current scheduler architectures because the nominal proportional fair metrics of the i-th flow may be offset by the term δΣⱼ₌₁^{N}αᵢⱼTⱼ(τ). As will be described in further detail below, any θ_{c}-fair function and priority offset may be implemented. The slicing logic may be transparent to the other functional blocks of the MAC scheduler. The term 6 may vary, depending on the implementation. For example, the term δ may be related to the reaction time of the algorithm when its constraint is violated. There may be a signal to this mechanism (e.g., in the MAC layer) that communicates the desired reaction time.

Scheduling performance may be improved using the token counter approach. Consider a scenario where the flows can be divided into two broad categories. The first category may comprise flows with intrinsic rate limitations, yielding non-full buffer conditions, such as URLLC flows. The second category may comprise best-effort flows with full buffers, such as MBB flows. The weights of the latter category of flows may be governed by equation (1), and the former category of flows may be scheduled in any way compliant with equation (2).

Given the traffic rates of the first category of flows and the channel characteristics of the flows, the flows may be scheduled in a manner that for the slices, the aggregate rate constraint may be satisfied, or the associated flows may receive an average rate equal to their average traffic rate (or both). Under the above conditions, the token counter approach may have various advantageous properties. The combined token counters and scheduling weights may be used to satisfy the high-level performance requirements associated with the various slices. Moreover, the combined token counters and scheduling weights may maximize the proportional fair rate objective for the category of best-effort flows over a certain rate region. The latter region may depend on how the high-priority flows are scheduled, but may be determined by the left-over resources and the various slice constraints.

Additional technical details on the performance of the slicing approach will now be described. For brevity, the case of a single frequency in which one user can be served in each time slot is described (e.g., where MU-MIMO might not be used). The dependence on λ may be dropped.

Various exemplary notations may be used:
I={1, . . . , M}: e.g., set of flows
I₀⊆I: e.g., set of best-effort/utility-based flows
U(·): e.g., concave throughput utility function for flows in class I₀
K: e.g., number of additional priority classes (with lower index indicating lower priority level)
Iₖ⊆I: e.g., set of priority class-k flows, k=1, . . . , K
k(i): e.g., class index of the i-th flow.
Gᵢ(τ): e.g., traffic rate of flow i∈I\I₀ in time slot τ
Qᵢ(τ): e.g., buffer content of flow i∈I at start of time slot ∈
Sᵢ (τ): e.g., aggregate rate assigned to flow i∈I across frequencies (e.g., all frequencies) in time slot τ
Rᵢ(τ): e.g., exponentially smoothed rate of flow i∈I at start of time slot τ
Tⱼ(τ): e.g., value of token counter at start of time slot τ, associated with j-th network slice/rate constraint Σ_{i∈I}αᵢⱼRᵢ(τ)≥βⱼ, j=1, . . . , N

Wᵢ(τ): e.g., scheduling weight of flow i∈I in time slot τ

It may be assumed that priority class 0 comprises best-effort/utility-based flows (e.g., MBB), while higher-priority traffic, like enhanced mobile broadband (eMBB) retransmissions and URLLC, may be included in priority classes 1, . . . , K.

The network slice/rate constraints may either capture lower or upper bounds on weighted rate sums, depending on whether the coefficients αᵢⱼ and βⱼ are positive or negative.

The exponentially smoothed rate of flow i∈I₀ may be updated as: Rᵢ (τ+1)=(1−δ)Rᵢ(τ)+δSᵢ(τ). The exponentially smoothed rates of flows i∈I\I₀ might not be tracked.

The buffer content of flow i∈I may evolve as: Qᵢ(τ+1)=[Qᵢ(τ)−Sᵢ(τ)]⁺+Gᵢ(τ), where data generated from hybrid automatic repeat request (HARM) retransmissions might not contribute in both rate and buffer updates, since the rate might be updated on reception of a positive acknowledgment.

Token counters may be incremented or decremented in each time slot by, for example, the MAC scheduler. Whether the token counter is incremented or decremented may depend on whether the rates or resources provided to that slice respectively fall short of or exceed a long-term target.

The token counter associated with the j-th network slice/rate constraint, j=1, . . . , N may be incremented in slot τ by βⱼ and decremented by Σ_{i∈I}αᵢⱼSᵢ(τ):

$${T}_{j} ( τ + 1 ) = {[ {T}_{j} ( τ ) + {β}_{j} - {\sum }_{i ∈ I} {α}_{i j} {S}_{i} ( τ ) ]}^{+} . \qquad ( 3 )$$

As previously described, the token counter may be capped at a finite maximum value Tₘₐₓ. When a token counter runs close to Tₘₐₓ and the cap is frequently applied, this may provide an indication that the corresponding network slice/rate constraint might not be achieved and may need to be renegotiated.

Critical traffic conditions may also be detected by applying dedicated thresholds to the token values, accordingly activating some higher layer's procedures, such as admission control and overload control. The system may start refusing to accept new connections, or some users may be downgraded to a lower QoS and/or disconnected from the system.

The slot-by-slot and per-frequency allocation of resources may be governed by the scheduling weights Wᵢ(τ). The scheduling weights may reflect the relative priority levels of the various flows and may incorporate the token counter values Tⱼ(τ) to account for the network slice/rate constraints. The scheduling weights might not directly depend on instantaneous channel conditions.

For each flow and/or user, a sum (e.g., a scaled sum) of the token counters of the slices that include the flow and/or user may be added as an offset to its scheduling weight. This may raise the level of priority for flows and/or users that are included in slices for which the resource or rate guarantees are not met. An exemplary scaled sum of the token counters of the slices that include the i-th flow and/or user may be represented as Vᵢ(τ):

$${V}_{i} ( τ ) = δ {\sum }_{j = 1}^{N} {T}_{j} ( τ )$$

The scaled sum may be added as an offset to the scheduling weight Wᵢ (τ), and therefore the scheduling weight Wᵢ(τ) may be determined based on the token counter(s) of slice(s), such as a scaled sum of token counters. The scheduler may allocate transmission resources to the various flows and/or users in time slot τ so as to maximize the weighted sum rate Σᵢ₌₁^{M}[Vᵢ(τ)+Wᵢ(τ)]Sᵢ(τ).

For best-effort flows i∈I₀ (e.g., MBB flows), the scheduling weight Wᵢ(τ) may be set as Wᵢ(τ)=U′(Rᵢ(τ)) and/or as:

$${W}_{i} ( τ ) = {U}^{′} ( {R}_{i} ( τ ) ) + δ {\sum }_{j = 1}^{N} {α}_{i j} {T}_{j} ( τ ) , \qquad ( 4 )$$

where U′(·) may be the derivative of a throughput utility function (e.g., a concave throughput utility function) and thus decreasing, e.g., U(x)=log(x) so U′(x)=1/x for the proportional fair throughput criterion.

The scheduling weight for higher-priority flows (e.g., URLCC flows) i ∈I\I₀ may be set as:

$${W}_{i} ( τ ) = {Δ}_{k ( i )} + δ {\sum }_{j = 1}^{N} {α}_{i j} {T}_{j} ( τ ) , \qquad ( 5 )$$

where Δₖ₍ᵢ₎ may comprise a positive offset which captures the priority level of flow i. This may be the same as the offset Δᵢ that was described above, such as with respect to equation (2). Note that in equation (2), the priority flows' weight may correspond to a prioritized maximum aggregated throughput solution. Some fairness for these flows may also be inserted to prevent starvation in a burst of high priority traffic, such as by adding a term proportional to (Rᵢ(τ))^{-γ}. Moreover, the k-th class offset with respect to the previous one, e.g., (Δₖ−Δₖ₋₁), may be large relative to the values that U′(Rᵢ(τ)) normally assume, to preserve the priority ordering. In some systems, the values of U′(·) may be thresholded between a maximum and a minimum value, such as to prevent numerical issues due to very bursty traffic. In the examples below, the thresholds on U′(·) may neglected, e.g., to preserve the concavity of U(·).

The allocation of resources in time slot τ may be aimed at maximizing the instantaneous weighted sum rate:

$${\sum }_{i ∈ I} {S}_{i} ( τ ) {W}_{i} ( τ )$$

subject to the rate constraints and the buffer content related ones Sᵢ(τ)≤Qᵢ(τ) for each i∈I.

As an alternative to the above-described weight-driven scheduling decisions, allocation of resources to (some of) the higher-priority flows i∈I \I₀ may be dictated by strict priority mechanisms, resource reservations, and/or explicit resource shares (e.g., weighted round robin), such as if the residual resources are allocated among the best-effort flows i ∈I₀ with the aim to maximize:

Σ_{i∈I}_{₀}Sᵢ(τ)Wᵢ(τ)

The rates received by the higher-priority flows may count toward the network slice/rate constraints that include such flows, but the latter constraints might not be enforced by raising or reducing the priority levels of these flows, and might affect the best-effort flows. This may make a potential difference and, for example, prevent throttling if a particular network slice includes high-priority flows whose aggregate traffic rate exceeds the associated target. The weight-driven scheduling decision may have the positive effect of offering an additional degree of freedom, given by the choice of Δₖ ∀k, to protect different operators' slices.

Various advantages of the approaches are possible. Hard priority may prioritize URLLC over MBB, even if a slice constraint is violated. Hence, latency performance for URLLC flows may be preserved. An effective admission control/overload control mechanism may be in place to handle misbehaving URLLC flows. Some weight-driven approaches may penalize misbehaving slices, even if they comprise high-priority flows. Assuming that the high-priority flows consume a certain fraction of resources, one or more aspects herein may be used to analyze how the utility-based flows consume the remaining resources subject to the slice constraints.

If αᵢⱼ=γᵢI_{{j∈Kj}}, with γᵢ being the average amount of resource units used to provide a unit transmission rate to flow i (e.g., 1/γᵢ may be the average transmission rate per resource unit), then the j-th network slice constraint may represent a lower bound for the average aggregate amount of resources allocated to the flows in the set Kⱼ⊆1. This may be in contrast with the previous formulation of equation (3), which may allow formulating constraints based on the flow's rate. In alternative examples, such a lower bound may be enforced by introducing a token counter of the form:

$${Y}_{j} ( τ + 1 ) = {[ {Y}_{j} ( τ ) + {β}_{j} - {\sum }_{i ∈ {K}_{j}} {X}_{i} ( τ ) ]}^{+}$$

with Xᵢ(τ) being the amount of resources allocated to flow i in time slot τ. A term δXᵢ(τ)Yⱼ(τ) may be added to the nominal scheduling metric Sᵢ(τ)Wᵢ(τ) for each of the flows i∈Kⱼ.

Priority class 0 with the best-effort/utility-based flows may correspond to commodity (e.g., utility) nodes, while the long-term rate/network slice constraints may correspond to processing nodes. The priority classes 1, . . . , K flows may be handled as a limiting case of processing nodes.

Various extensions to one or more of the algorithms discussed above will now be described. One or more algorithms may handle a plurality of QoS classes, such as 5G QoS indicator (5QI) classes. One or more algorithms described above may assume a case of two QoS classes, such as MBB and URLLC. However, there may be more than two QoS (e.g., 5QI) classes that may capture different degrees of prioritization. This may be captured by different instantiations of the utility function. In particular, for a general class c, utility parameters K_{c} and θ_{c}, as well as a priority offset Δ_{c}, may be used. The utility function for class c may have derivative U_{c}′(x)=K_{c}x^{-θc} (and may be a θ_{c}-fair function). The general weight for a flow i in class c may be:

$${W}_{i} ( τ ) = {{K}_{c} ( {R}_{i} ( τ ) )}^{- {θ}_{c}} + δ {\sum }_{j = 1}^{N} {α}_{ij} {T}_{j} ( τ ) + {Δ}_{c} . \qquad ( b )$$

Slice maximum rate requirements may be handled. In the above discussion, βⱼ may represent a lower bound on the resources used for slice j, and Tⱼ(·) may be updated according to:

$${T}_{j} ( τ + 1 ) = max \{ {T}_{j} ( τ ) + {β}_{j} - {\sum }_{j} {α}_{ij} {S}_{i} ( τ ) , 0 \}$$

Each slice j may have both a lower bound βⱼ^{min} and an upper bound βⱼ^{max}, that may be obtained by opportunely changing the signs of equation (a). Both bounds may be supported by updating the value of Tⱼ(·) according to:

$${T}_{j} ( τ + 1 ) = \{ \begin{matrix}{T}_{j} ( τ ) + {β}_{j}^{min} - {\sum }_{i} {α}_{ij} {S}_{i} ( τ ) & if {T}_{j} ( τ ) \geq 0 \\ {T}_{j} ( τ ) + {β}_{j}^{max} - {\sum }_{i} {α}_{ij} {S}_{i} ( τ ) & if {T}_{j} ( τ ) < 0\end{matrix} \qquad ( c )$$

The formulation of equation (c) may allow good readability and quick implementation. However, when Tⱼ is equal to zero, it may introduce a small oscillation in the token counter that might not affect the total system behavior.

A formulation of the token counter update that deals with the case of Tⱼ=0 will now be described. Additional update rules for the case when the tokens are at zero may be introduced. In particular, if both a lower bound βⱼ^{min} and an upper bound βⱼ^{max} constraint exist, both bounds may be supported by updating the value of Tⱼ(·) according to:

$${T}_{j} ( τ + 1 ) = \{ \begin{matrix}{T}_{j} ( τ ) + {β}_{j}^{min} - {\sum }_{i} {a}_{ij} {S}_{i} ( τ ) & if {T}_{j} ( τ ) > 0 \\ {T}_{j} ( τ ) + {β}_{j}^{max} - {\sum }_{i} {α}_{i j} {S}_{i} ( τ ) & if {T}_{j} ( τ ) < 0 \\ {β}_{j}^{min} - {\sum }_{i} {α}_{ij} {S}_{i} ( τ ) & \begin{matrix}if {T}_{j} ( τ ) = 0 and \\ {\sum }_{} {α}_{ij} {S}_{i} ( τ ) < {β}_{j}^{min}\end{matrix} \\ {β}_{j}^{max} - {\sum }_{i} {α}_{ij} {S}_{i} ( τ ) & \begin{matrix}if {T}_{j} ( τ ) = 0 and \\ {\sum }_{} {α}_{ij} {S}_{i} ( τ ) > {β}_{j}^{max}\end{matrix} \\ 0 & otherwise\end{matrix} \qquad ( d )$$

Slice resource share requirements may be handled. The above formula (c) for updating Tⱼ(·) may apply when upper/lower bounds on the bitrate provided to slice j exist. If instead bounds on the share of resources provided to the slice exist, one or more adjustments may be made. Let d_{i,Π,τ,λ} be the fraction of resources assigned to flow i if the set of flows Π is scheduled on resource (τ, λ). Let Xᵢ(τ) be the total fraction of resources assigned to flow i at time τ. First, slice resource constraints may be specified in terms of the long-term average of Xᵢ(τ), rather than Rᵢ(τ) (which may be the long-term average of Sᵢ(τ)). Second, Tⱼ(·) may be updated based on the Xᵢ(τ) values, rather than the Sᵢ (τ) values. Third, resource (τ, λ) may be assigned to the set of flows Π that maximizes,

$$( {{K}_{c} ( {R}_{i} ( τ ) )}^{- {θ}_{c}} + {Δ}_{c} ) {c}_{i , Π , τ , λ} + ( δ {\sum }_{j = 1}^{N} {α}_{i j} {T}_{j} ( τ ) ) {d}_{i , Π , τ , λ}$$

In other words, the tokens may be multiplied by the resources associated with a scheduling decision, not by the bit rate associated with that decision.

Latency considerations may be introduced directly into the token counters. In the above, latency constraints for URLLC traffic may be assumed to be handled by the priorities Δ_{c}. This may induce a natural priority between flows. In the case of looser latency requirements, however, a more flexible approach may be used, and a class of tokens based on latency may be introduced. Two exemplary approaches to deal with these token counters will now be described. One approach may be to keep track of them each time the weights are updated. This approach may be suited for DRBs with medium-to-high packet arrival rates. Another approach may be to intervene when a packet is transmitted. This approach may allow dealing with more sporadic traffic sources.

For the updates in time approach, Dᵢ(τ) may be the average delay of the packets in flow i at TTI index τ. If the latency budget is B, and the head-of-line delay for flow i in slice j at time τ is e(τ), Dᵢ(τ)=δⱼDᵢ(τ−1)+(1−δⱼ)max(e(τ)−B,0). A constraint of the form

$${\sum }_{i = 1}^{M} {α}_{i j} {D}_{i} ( τ ) \leq 0 ,$$

may be introduced by adding a term of the form δⱼΣᵢ₌₁^{M}αᵢⱼDᵢ(τ) to the flow weight. A large value of αᵢⱼ may be desired if the token counter for flow i is to react drastically. Note that the time window of the constraint may be controlled by changing the smoothing factor δⱼ.

For the updates at each packet transmission approach, discrete events corresponding to a packet transmission to model time may be used. For flow i in slice j, Dᵢ(n) may be the average delay of the packets at the n-th transmission, and e(n) may be the end-to-end MAC delay experienced in the n-th packet transmission. Dᵢ(n)=δⱼDᵢ(n−1)+(1−δⱼ)max(e(n)−B,0), and the corresponding constraint may be

$${\sum }_{i = 1}^{M} {α}_{ij} {D}_{i} ( n ) \leq 0 .$$

by adding a term of the form δⱼΣᵢ₌₁^{M}αᵢⱼDᵢ(n) to the flow weight. The δⱼ term may now define a time window in the discrete time series corresponding to packet transmissions. The desired reliability (1−E) of this latency budget may be achieved by setting δⱼ=∈.

The token counters Tⱼ(·) may interface with admission control/overload control, which may reside, for example, at the service data adaptation protocol (SDAP) layer in 5G. If Tⱼ(τ) rises above a threshold, then this may indicate that the scheduler is having difficulty meeting the slice requirements for slice j. In this case, overload control may temporarily suspend the enforcement for slice j. In addition, admission control may suspend the introduction of new slice requirements until the token values recover.

Flows may be grouped into radio bearers (e.g., data radio bearers (DRBs)), protocol data unit (PDU) sessions, and/or slices. PDU sessions may comprise connections between the UE and the data network, and a UE may have multiple PDU sessions, such as in different slices. The UE may receive services through the PDU session(s). Each PDU session of the UE might belong to one slice. A PDU session may comprise multiple flows. The flows of a PDU session may be mapped to different DRBs. Additionally or alternatively, flows with similar QoS characteristics may be mapped to the same DRB.

Slice parameters (e.g., requirements) may be communicated to the scheduler. For example, slice requirements may be communicated to the scheduler in a similar manner to the 5QI requirements (or other QoS indicators) for single flows. For example, flow characteristics such as guaranteed bit rate (GBR), non-GBR, priority, etc., along with numerical parameters such as guaranteed flow bit rate (GFBR) may be communicated. The slice specifications may be similar. Each slice may have 5QI (or other QoS indicator) parameters specifying slice characteristics together with quantities such minimum bitrate, minimum resource share, etc.

Slice parameters may be updated. Initial slice requirements specified at the SDAP layer may become inappropriate during the lifetime of the slice. For example, the flows in a slice might not have sufficient resources to handle their traffic (e.g., high-definition video flows experiencing poor video quality). The flow performance might not achieve the service level agreements (SLAs) negotiated between the network operator and the slice owner. The MAC scheduler might not support the 5QI requirements for the slices. In this case, overload/admission control may be activated as previously described. A self-learning feedback loop in which slice performance relative to the 5QI requirements is measured at the MAC scheduler may be used. This could be done, for example, by monitoring the token levels. In addition, application-level performance (e.g., video quality) and SLA compliance may be measured at the application and policy layers. This information may be fed to the SDAP layer which may then make admission/overload control decisions and/or update the 5QI parameters for the slices.

Examples of results with 3 slices, 5 users per slice, and 5 subbands will now be described. A user's spectral efficiency within a subband may take a discrete value, such as one of 16 discrete values between 0 and 5.55. Other values may be used. Fading may adjust the spectral efficiency across subbands but not across time slots. The β values may specify, for example, the minimum bitrate for each slice. These values may be specified in terms of average bitrate per subband.

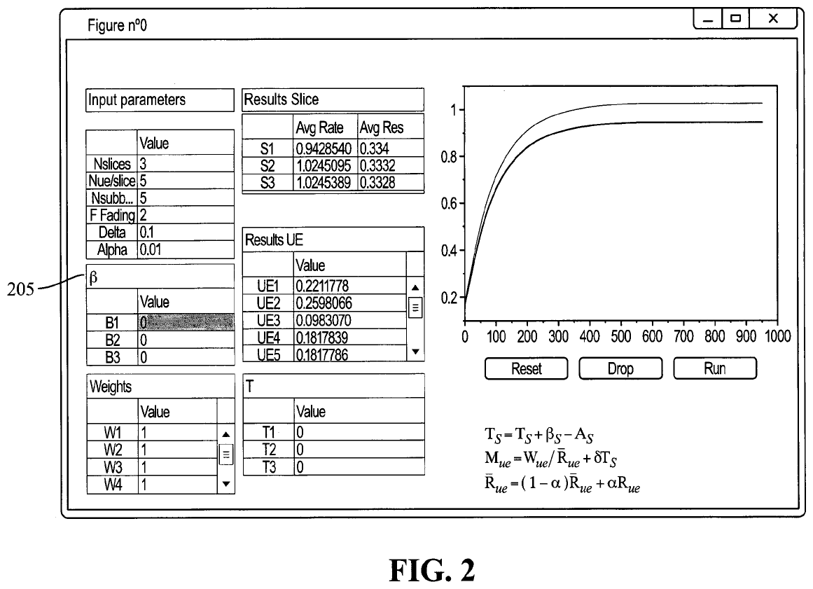

FIG. 2 illustrates an example of how bitrates of slices may change with no slice constraints, such as in a proportional fair algorithm. For example, the β values 205 for each of the three slices may be set to 0. The average bitrate over time for the slice S1 may be 0.94. The average bitrate over time for the slice S2 may be 1.2. The average bitrate over time for the slice S3 may be 1.2.

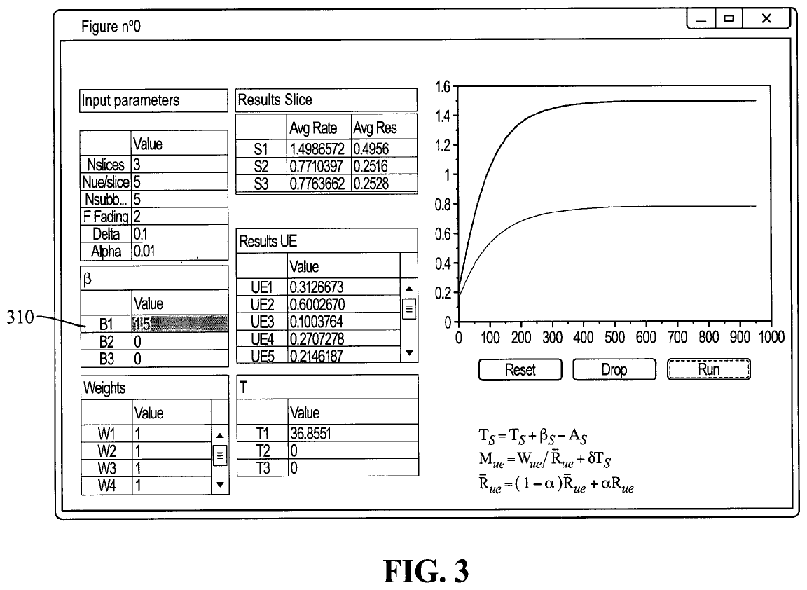

FIG. 3 illustrates an example of how bitrates of slices may change when one slice has a minimum bitrate constraint of, for example, 1.5 Mbps. For example, the β value 310 for slice S1 may be set to 1.5. Slice S1 may meet its constraint (e.g., an average bitrate of 1.5), but the aggregate bitrates of the other two slices may be reduced. For example, the average bitrate for slice S2 may be 0.77, and the average bitrate for slice S3 may be 0.78.

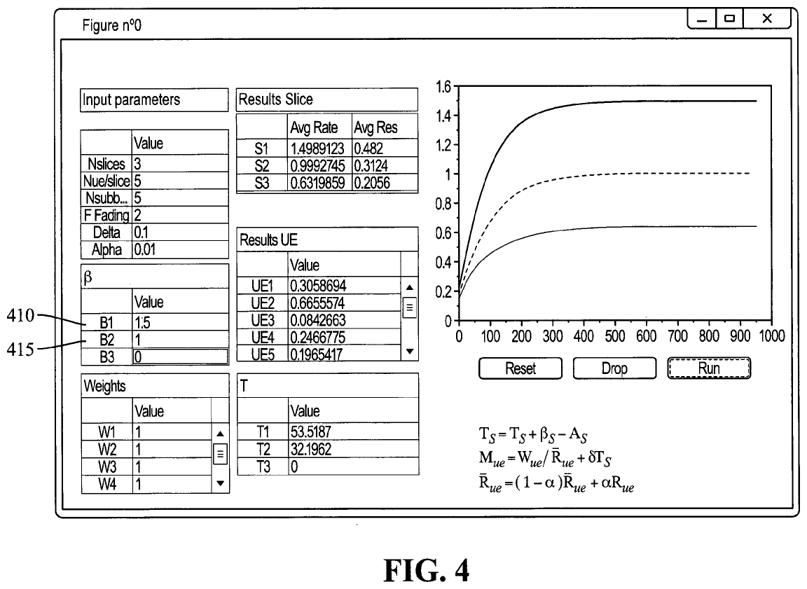

FIG. 4 illustrates an example of how bitrates of slices may change when slice S1 has a minimum bitrate constraint B1 410 of, for example, 1.5 Mbps, and slice S2 has a minimum bitrate constraint B2 415 of, for example, 1.0 Mbps. In this example, the third slice S3 may receive an even smaller bitrate (e.g., 0.63) in order to satisfy the constraints of the other two slices.

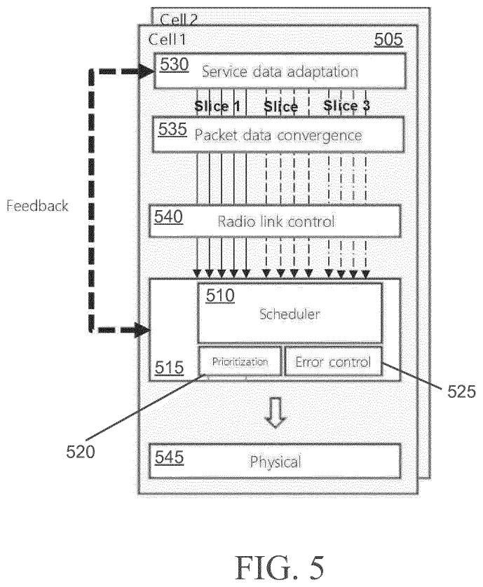

FIG. 5 illustrates an exemplary slicing control scheme according to one or more embodiments described herein. The slicing control scheme may be performed by one or more computing devices, such as a base station (or other access point) serving one or more stations (e.g., mobile user devices) within the base station's cell (e.g., cell 1 505). A scheduler 510 may be associated with the base station (or a plurality of base stations). For example, the scheduler 510 may be within the base station. The scheduler 510 may be used to schedule packets for transmission to stations. The scheduler may comprise a media access control (MAC) layer scheduler, and may be at the MAC layer 515. The MAC layer 515 may also include, for example, one or more prioritizers 520. The prioritizer(s) 520 may comprise a prioritization multiplexer (MUX)/demultiplexer (DEMUX), such as a logical channel prioritization (LCP) MUX/DEMUX. The MAC layer 515 may also include, for example, one or more error controllers 525, such as hybrid automatic repeat request (HARM) error controller.

Other layers may be included in the cell 505. For example, a service data adaptation protocol (SDAP) layer 530 may be used to, for example, map flow(s) to DRB(s). The cell 505 may comprise a packet data convergence protocol (PDCP) layer 535. The cell 505 may comprise a radio link control (RLC) layer 540. The cell 505 may comprise a physical (PHY) layer 545. The PHY layer may connect the MAC layer 515 to one or more physical links.

As previously explained, one or more scheduling weights W for transmitting data to stations may be used. The system may generate a scheduling weight for a user based on, for example, a weight factor, a proportional fairness factor, one or more additional weights, and/or a priority offset. For example, for a user i belonging to slice j (and not to other slices), at time k, a weight may be determined according to the following exemplary algorithm:

Wᵢ(k)=Kᵢ·(R̅ᵢ (k))⁻¹+δᵢα_{i,j}Tⱼ(k)+Δᵢ

Kᵢ may correspond to a weight factor. The weight factor may be determined and/or updated (e.g., slowly) by closed-loop control.

(R̅ᵢ(k))⁻¹ may correspond to a proportional fairness factor. The proportional fairness factor may be determined and/or adjusted by a congestion manager, such as the SDAP 530.

δᵢα_{i,j}Tⱼ(k) may correspond to an additional weight. The δᵢα_{i,j} scheduling parameter may be determined and/or updated (e.g., slowly) by a closed-loop control. Additionally or alternatively, the δᵢα_{i,j} scheduling parameter may be determined by, for example, the SDAP, and may eventually go through an interface (e.g., an F1 interface) between a central unit (CU), which may be where the SDAP is located, and a distributed unit (DU), which may be where the MAC scheduler is located. The token counter Tⱼ(k) may be tracked and/or determined by a scheduler, such as the MAC scheduler 510.

Δᵢ may correspond to a priority offset. The priority offset may be determined and/or adjusted by a congestion manager, such as SDAP 530.

Messages and/or fields may be used to allow the MAC layer 515 to communicate, with higher layers, information about the performance or behaviour of each slice. Exemplary information may include the token counter value of each slice, which may be shared periodically, e.g., every 100 ms, 200 ms, 1000 ms, etc. This may allow the higher layers to monitor the health of each slice, allowing for interfaces between the MAC layer and higher layers to react to critical conditions and, for example, renegotiate the SLA.

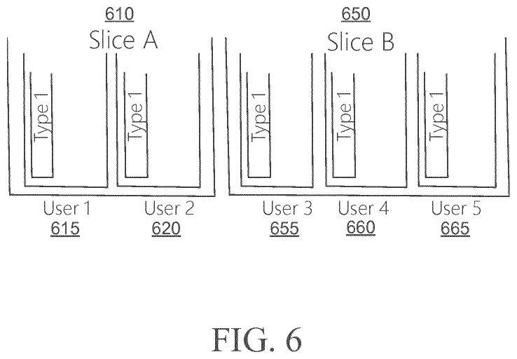

FIG. 6 illustrates an example of adjusting one or more token counters according to one or more embodiments described herein. FIG. 6 illustrates an example with two slices, slice

A 610 and slice B 650. Users may be assigned to slices. For example, user 1 615 and user 2 620 may be assigned to slice A 610. User 1 and/or user 2 may communicate via a traffic type 1, such as MBB. User 3 655, user 4 660, and user 5 665 may be assigned to slice B 650. User 3 655, user 4 660, and user 5 665 may also communicate via a traffic type 1, such as MBB. The DRBs may have the same priorities, but be in different slices. Assume, for example, that slice A 610 has an SLA of 200 Mbps. If slice A 610 experiences a transmission rate higher than the SLA, such as 220 Mbps, a token counter T_{A}(k) may be decreased (e.g., by the MAC scheduler), such as down to 0. By decreasing the token counter T_{A}(k), the weights Wᵢ(k) for users 1 and 2 belonging to slice A 610 may also decrease. Accordingly, fewer resources may be assigned to slice A 610, freeing up resources to increase the transmission rate of other slices, such as slice B 650 or other slices. Slice B 650 may have, for example, an SLA of 300 Mbps. If slice B 650 experiences a transmission rate lower than the SLA for slice B 650, such as 280 Mbps, a token counter T_{B}(k) may be increased (e.g., by the MAC scheduler). By increasing the token counter T_{B}(k), the weights Wᵢ(k) for users 3, 4, and 5 belonging to slice B 650 may also increase. Accordingly, additional resources may be assigned to slice B 650 to increase the transmission rate of slice B 650. The resources may be taken from another slice, such as slice A 610. When the SLA for slice B 650 is met, such as the transmission rate for slice B 650 meeting or exceeding the SLA, T_{B}(k) may be maintained or decreased.

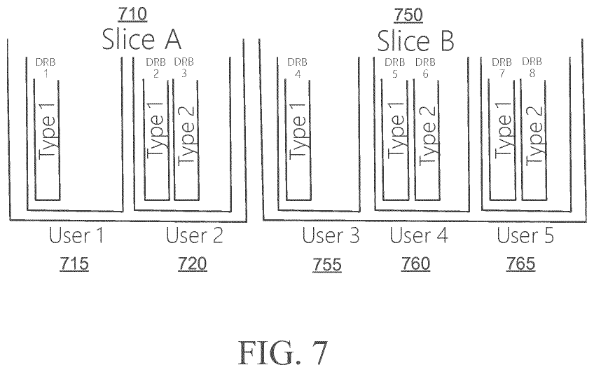

FIG. 7 illustrates an example of adjusting one or more token counters according to one or more embodiments described herein. In these examples, different types of traffic may be included in each slice. FIG. 7 illustrates an example with two slices, slice A 710 and slice B 750. User 1 715 and user 2 720 may be assigned to slice A 710. User 1 715 may communicate via a traffic type 1, such as MBB. User 2 720 may communicate via a traffic type 1, such as MBB, and via a traffic type 2, such as URLLC. User 3 755, user 4 760, and user 5 765 may be assigned to slice B 750. User 3 755 may communicate via a traffic type 1, such as MBB. User 4 760 and/or user 5 765 may communicate via a traffic type 1, such as MBB, and via a traffic type 2, such as URLLC. As previously explained, slice A 710 may have an SLA of 200 Mbps, and slice B 750 may have an SLA of 300 Mbps. If slice A 710 experiences a transmission rate higher than the SLA, such as 220 Mbps, a token counter T_{A}(k) may be decreased (e.g., by the MAC scheduler). On the other hand, if slice B 750 experiences a transmission rate lower than the SLA for slice B 750, such as 280 Mbps, a token counter T_{B}(k) may be increased (e.g., by the MAC scheduler).

Moreover, certain types of traffic (e.g., URLLC) may be prioritized over other types of traffic (e.g., MMB). As previously explained, a priority offset Δᵢ may be used to adjust the weight based on priority. For example, the weights for the DRB 1 and DRB 2 for slice A 710 may be determined as follows:

W₁(k)=1·(R̅ᵢ (k))⁻¹+δ₁α_{1,A}T_{A}(k)

W₂(k)=1·(R̅ᵢ (k))⁻¹+δ₂α_{1,A}T_{A}(k)

The scheduler may decrease T_{A}(k) over time because the transmission rate experienced by slice A 710 is higher than the SLA. A weight factor Kᵢ may be 1.

The weight for the DRB 3 for slice A 710 may be determined as follows:

W₃(k)=100·(R̅ᵢ(k))^{-0.5}+δ₃α_{3,A}T_{A}(k)+Δ₃

The scheduler may decrease T_{A}(k) over time because the transmission rate experienced by slice A 710 is higher than the SLA. A weight factor Kᵢ may be 100. The proportional fairness factor may be (R̅ᵢ(k)) ^{-0.5}. The weight W₃(k) may also factor (e.g., add) in the priority offset Δ₃ because DRB 3 may carry higher priority traffic (e.g., URLLC traffic).

The weights for the DRB 4, DRB 5, and DRB 7 for slice B 750 may be determined, respectively, as follows:

W₄(k)=1·(R̅ᵢ(k))⁻¹+δ₄α_{4,B}T_{B}(k)

W₅(k)=1·(R̅ᵢ(k))⁻¹+δ₅α_{5,B}T_{B}(k)

W₇(k)=1·(R̅ᵢ(k))⁻¹+δ₇α_{7,B}T_{B}(k)

The scheduler may increase T_{B} (k) over time because the transmission rate experienced by slice B 750 may be lower than the SLA. A weight factor Kᵢ may be 1.

The weight for the DRB 6 and DRB 8 for slice B 750 may be determined, respectively, as follows:

W₆(k)=50·(R̅ᵢ(k))^{-0.5}+δ₆α_{6,B}T_{B}(k)

W₇(k)=50·(R̅ᵢ(k))^{-0.5}+δ₇α_{7,B}T_{B}(k)

The scheduler may increase T_{B} (k) over time because the transmission rate experienced by slice B 750 may be lower than the SLA. A weight factor Kᵢ may be 50. For example, a scheduler parameter manager may determine to use the value 50. The scheduler parameter manager may additionally or alternatively determine the value of δ₈α_{8,B}. The proportional fairness factor may be (R̅ᵢ(k))^{-0.5}. Congestion management may be used to determine to use the value −0.5. The weight W₆(k) may also factor (e.g., add) in the priority offset Δ₆ because DRB 6 may carry higher priority traffic (e.g., URLLC traffic). Similarly, the weight W₈ (k) may factor (e.g., add) in the priority offset Δ₈ because DRB 8 may carry higher priority traffic (e.g., URLLC traffic). Congestion management may determine the priority offset Δ₆ and/or the priority offset Δ₈. In some examples, minimum/maximum over the guaranteed bit rate, resource share, and/or latency may be imposed.

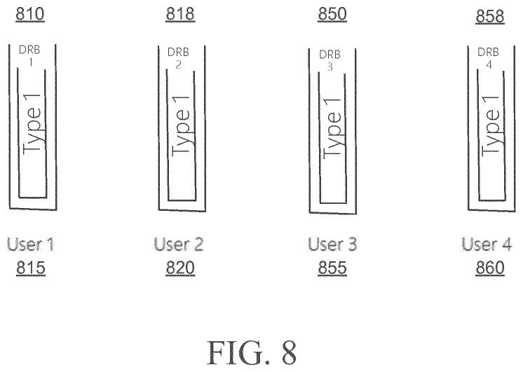

FIG. 8 illustrates an example of adjusting one or more token counters according to one or more embodiments described herein. FIG. 8 illustrates an example with four slices (e.g., slice 810, slice 818, slice 850, and slice 858), and each user (e.g., user 1 815, user 2 820, user 3 855, and/or user 4 860) may be assigned to a different respective slice. Each slice may comprise one or more DRBs for carrying traffic (e.g., DRB 1, DRB 2, DRB 3, and/or DRB 4), so there may be 1 DRB per user. Assume that the traffic for each user is of a traffic type 1, such as MBB. Assume that the SLA for each user is a guaranteed bit rate of 2 Mbps. If user l's experienced bitrate, is 2.5 Mbps, the token counter T₁(k) may be decreased. If user 2's experienced bitrate, is 5 Mbps, the token counter T₂(k) may also be decreased. If each of the token counters for slice 810 and slice 818 are set to 0, user 1 and user 2's respective weights W₁(k) and W₂(k) may be determined as follows:

W₁(k)=1·(R̅₁(k)⁻¹+δ₁α₁T₁(k)=(R̅₁(k))⁻¹

W₂(k)=1·(R̅₂(k)⁻¹+δ₂α₂T₂(k)=(R̅₂(k))⁻¹

If user 3's experienced bitrate, is 0.8 Mbps, the token counter T₃(k) may be increased to increase user 3's weight W₃(k). User 3's weight W₃(k) may be greater than 0. If user 4's experienced bitrate, is 0.5 Mbps, the token counter T₄(k) may be increased to increase user 4's weight W₄(k). In some examples, User 4's weight W₄(k) may be greater than user 3's weight W₃(k), which may be greater than 0. User 3 and user 4's respective weights W₃(k) and W₄(k) may be determined as follows:

W₃(k)=1·(R̅₃(k)⁻¹+δ₃α₃T₃(k)

W₄(k)=1·(R̅₄(k)⁻¹+δ₄α₄T₄(k)

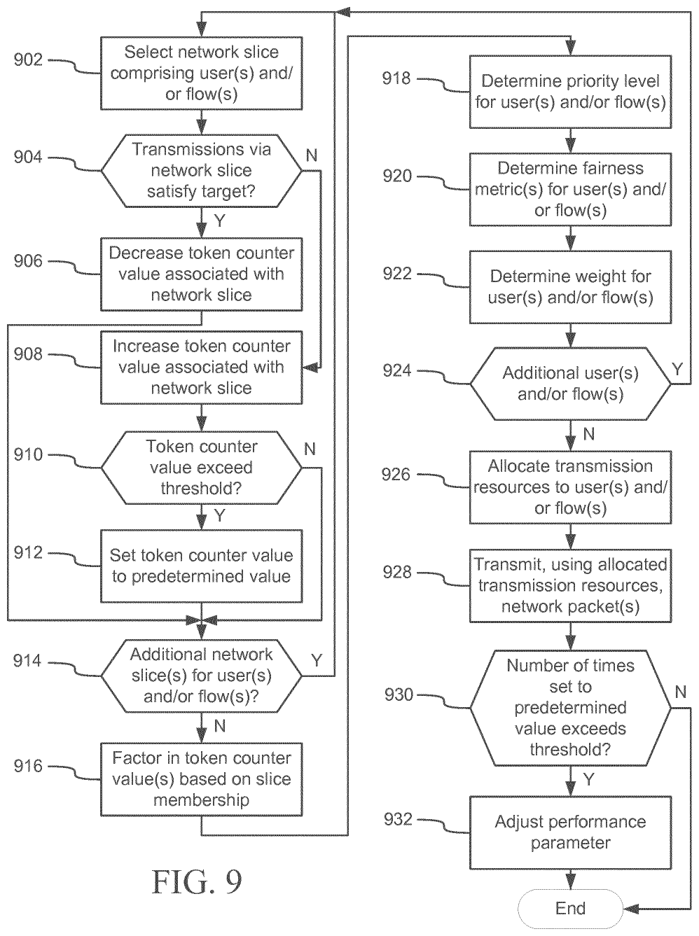

FIG. 9 illustrates an exemplary method of adjusting network slices according to one or more embodiments described herein. One or more of the steps illustrated in FIG. 9 may be performed by a computing device, such as an access node 130 illustrated in FIG. 1 or an apparatus or computing device 1012 illustrated in FIG. 10 (as will be described in further detail below). The apparatus or computing device may comprise at least one processor and at least one memory including computer program code. The at least one memory and the computer program code may be configured to, with the at least one processor, cause the apparatus or computing device to perform one or more of the steps illustrated in FIG. 9. Additionally or alternatively, a computer-readable medium may store computer-readable instructions that, when executed by a computing device, may cause the computing device to perform one or more of the steps illustrated in FIG. 9.

In step 902, the computing device may select a network slice. As previously described, a network slice may comprise one or more user(s) and/or one or more flow(s). For example, one or more first user devices may be assigned to a first network slice, one or more second user devices may be assigned to a second network slice, and so on. An access node may transmit and/or receive data from each user via one or more of the user's flows. With brief reference to FIG. 7, user 1 715 may have a flow of type 1, which may be mapped to DRB 1. User 2 720 may have a flow of type 1, which may be mapped to DRB 2, and a flow of type 2, which may be mapped to DRB 3. Flows may be of different types, such as mobile broadband flows, ultra-reliable low-latency communication flows, etc. Various other examples of assigning user(s) and/or flow(s) to network slices were previously described. The computing device may select a network slice to analyze.

Returning to FIG. 9, in step 904, the computing device may determine whether transmissions via the selected network slice satisfy one or more targets. As previously explained, targets may comprise bitrate targets, throughput targets, resource share targets, latency targets, or other targets. Longer term performance parameters may be determined by, for example, service level agreements (SLAs). Based on whether transmissions via the network slice satisfy one or more target(s), the computing device may adjust one or more token counter values associated with the network slice. The token counter value(s) may be adjusted (e.g., increased, decreased, or maintained) relative to a previous token counter value for the network slice. Various examples of adjusting the token counter value based on a previous token counter value were previously described.

If transmissions via the network slice do not satisfy target(s) (step 904: N), the computing device may proceed to step 908, as will be described in further detail below. Transmissions might not satisfy targets if, for example, the bitrate experienced by the network slice does not meet or exceed a threshold bitrate, the throughput experienced by the network slice does not meet or exceed a threshold throughput, and/or the latency experienced by the network slice is greater than a threshold latency. If, on the other hand, transmissions via the network slice satisfy target(s) (step 904: Y), the computing device may proceed to step 906. Transmissions might satisfy targets if, for example, the bitrate experienced by the network slice meets or exceeds a threshold bitrate, the throughput experienced by the network slice meets or exceeds a threshold throughput, and/or the latency experienced by the network slice is less than or equal to a threshold latency. As previously explained, longer term threshold bitrate, throughput, and/or latency may be indicated in, for example, SLAs.

In step 906, the computing device may decrease the token counter value for the network slice (e.g., relative to a previous token counter value for the network slice) if transmissions via the network slice satisfy target(s). The token counter value may be decreased if, for example, positive token counter values are used. As previously explained, the token counter value may be set to zero (or a different predetermined low value) in some circumstances. Decreasing the token counter value may decrease the weight associated with the user(s) and/or flow(s) of the network slice. Consequently, network resources may be freed up for other network slice(s). If negative token counter values are used, the token counter value may be increased in step 906. The token counter value may be set to zero (or a different predetermined high value) in some circumstances. Increasing the token counter value may decrease the weight associated with the user(s) and/or flow(s) of the network slice. The method may proceed to step 914, as will be described in further detail below.

In step 908, the computing device may increase the token counter value for the network slice (e.g., relative to a previous token counter value for the network slice) if transmissions via the slice do not satisfy target(s). The token counter value may be increased if, for example, positive token counter values are used. Increasing the token counter value may increase the weight associated with the user(s) and/or flow(s) of the network slice. Consequently, more network resources may be used to transmit data via the network slice, which may, for example, increase the bitrate, throughput, or other target experienced by the network slice. In some examples, the increased token counter value may exceed a threshold token counter value (e.g., a maximum token counter value). If negative token counter values are used, the token counter value may be decreased in step 908 if transmissions via the slice do not satisfy target(s). Decreasing the token counter value may increase the weight associated with the user(s) and/or flow(s) of the network slice.

In step 910, the computing device may determine whether the increased token counter value (e.g., for positive token counter values) would exceed a threshold token counter value or would fall below a threshold token counter value (e.g., for negative token counter values). If not (step 910: N), the method may proceed to step 914, as will be described in further detail below. If, on the other hand, the increased token counter value (e.g., for positive token counter values) would exceed the threshold token counter value or would fall below a threshold token counter value (e.g., for negative token counter values) (step 910: Y), the method may proceed to step 912.

In step 912, the computing device may set the token counter value (e.g., that would have exceeded the threshold token counter value) to a predetermined token counter value. The predetermined token counter value may be, for example, the threshold token counter value or a value less than the threshold token counter value (e.g., for positive token counter values) or a value greater than the threshold token counter value (e.g., for negative token counter values). Thus, in some examples, the token counter value might not exceed (or fall below) a predetermined token counter value, even if target(s) have not been satisfied. The method may proceed to step 914.

In step 914, the computing device may determine whether there are additional network slice(s) for the user(s) and/or flow(s). For example, user(s) and/or flow(s) may be assigned to one or more other network slice(s). As will be described in further detail below, the weight determined for the user(s) and/or flow(s) may be based on one or more tokens associated with slice(s) corresponding to the user(s) and/or flow(s). If there are additional network slice(s) for the user(s) and/or flow(s) (step 914: Y), the method may return to step 902 to identify the additional network slice(s) and/or determine token counter(s) for those additional network slice(s). If there are not additional network slice(s) for the user(s) and/or flow(s) to analyze (step 914: N), the method may proceed to step 916.

In step 916, the computing device may factor in token counter value(s) based on slice membership. As previously explained, a network slice may have one or multiple token counters. If the network slice has one token counter, the computing device may use that token counter value to determine a weight for the flow(s) and/or user(s), as will be described in further detail below. If the network slice has multiple token counters, the computing device may factor in each of the token counter values to determine the weight for the flow(s) and/or user(s). For example, a weighted sum of the token counter values may be used to determine the weight for the flow(s) and/or user(s), as will be described in further detail below.

In step 918, the computing device may determine a priority level for the flow(s) and/or user(s). As previously explained, different types of flows may have different priority levels. For example, URLLC flows may have higher priority levels than MBB flows. A priority offset may be used to determine a weight to use for the flow(s) and/or user(s). For example, the priority offset may increase the weight for higher priority flows and/or decrease the weight for lower priority flows.

In step 920, the computing device may determine one or more fairness metrics that may be used to determine the weight for the flow(s) and/or user(s). As previously explained, exemplary metrics include, but are not limited to, proportional fairness (PF), maximum throughput (MT), γ-fair, etc.

In step 922, the computing device may determine a weight for the flow(s) and/or user(s). The weight may be determined based on the token counter value for the network slice(s) that the flow(s) and/or user(s) belong to. If there are a plurality of token counter values (e.g., for a plurality of network slices), the weight may be determined based on the plurality of token counter values. Various other factors, such as a priority level for the flow(s) and/or user(s), fairness metrics, and other factors, may be used to determine the weight to assign to the flow(s) and/or user(s). For example, the weight may be determined according to the following exemplary algorithm:

Wᵢ(k)=Kᵢ·(R̅ᵢ(k))⁻¹+δᵢα_{i,j}Tⱼ(k)+Δᵢ

As previously explained, Kᵢ may correspond to a weight factor, (R̅ᵢ(k))⁻¹ may correspond to a proportional fairness factor, δᵢα_{i,j}Tⱼ(k) may correspond to an additional weight, Tⱼ(k) may correspond to the token counter value determined for the slice, and Δᵢ may correspond to a priority offset. Various other algorithms for determining the weight were previously described and may similarly be used, in step 922, to determine the weight. For example, if a plurality of token counters (e.g., from a plurality of network slices) are used, a sum of the token counters (e.g., a weighted sum, such as δᵢΣⱼⱼ₌₁^{N}α_{i,j}Tⱼ(k)) may be used to determine the weight for the flow(s) and/or user(s).

In step 924, the computing device may determine whether there are additional users and/or flows to be scheduled. If so (step 924: Y), the computing device may return to step 902 to identify a network slice associated with the additional user and/or flow, determine one or more token counter value(s) for network slices associated with the additional user and/or flow, determine a weight for the additional user and/or flow, etc. If there are not additional users and/or flows to be scheduled (step 924: N), the method may proceed to step 926.

In step 926, the computing device may allocate transmission resources to the various flows and/or users, such as based on the weight determined for each flow and/or user. For example, the computing device may schedule, based on the determined weight(s), transmissions to one or more user devices using the network slice. As previously explained, the computing device may use, for example, a MAC scheduler to adjust token counter value(s) and/or schedule transmissions to user devices. In some examples, the computing device may comprise a base station. Allocating transmission resources may be performed after the token counter values for slices (e.g., all slices) and the weights for flows and/or users (e.g., all flows and/or users) have been determined. The method may proceed to step 928 to transmit network packet(s), such as according to the allocation of transmission resources in step 926.

In step 928, the computing device may transmit, using the allocated transmission resources, network packet(s) to one or more user devices in the corresponding network slice(s). Transmission of networks packets may be performed after the token counter values for slices (e.g., all slices) and the weights for flows and/or users (e.g., all flows and/or users) have been determined. The computing device may continue to monitor whether target(s) for the network slice are satisfied, such as in the transmission and/or future transmissions. Token counter values, weights, and other parameters may be adjusted based on whether target(s) for the network slice are satisfied. For example, one or more of the steps previously described and illustrated in FIG. 9 may be repeated for the network slices and users and/or flows, and the computing device may allocate network resources to the various flows and/or users accordingly.

In some situations, the computing device may set the token counter value for a particular network slice to a predetermined value (e.g., a maximum value for positive token counter values or a minimum for negative token counter values) multiple times. This may indicate that performance parameters for that network slice may need to be adjusted. In step 930, the computing device may determine the number of times (e.g., within a span of time, such as seconds, or a number of transmissions) that the token counter value for each network slice has been set to the predetermined (e.g., maximum or minimum) token counter value. If the number of times the token counter value has been set to the predetermined value does not exceed a threshold number of times (step 930: N), the method may end or may repeat one or more of the steps illustrated in FIG. 9 to adjust token counter values, weights, and other parameters for future resource allocations and/or transmissions. If, on the other hand, the number of times the token counter value has been set to the predetermined token counter value exceeds the threshold number of times (step 930: Y), the method may proceed to step 932.

In step 932, the computing device may adjust a performance parameter for the network slice, such as based on a determination that token counter values associated with the network slice match the predetermined token counter value at least a threshold number of times. A minimum bitrate for the slice may be lowered, a minimum throughput for the slice may be lowered, latency requirements may be relaxed, and/or other performance parameters may be adjusted. For example, a service level agreement may be adjusted. Additionally or alternatively, admission control/overload control (AC/OC) procedures may also be triggered, as previously explained. Once the computing device determines an appropriate token counter value for the slice, the computing device may use the token counter value and other values to determine a weight to use for each flow and/or user.

FIG. 10 illustrates an example apparatus, in particular a computing device 1012, that may be used in a communication network such as the one illustrated in FIG. 1, to implement any or all of stations 105, 110, 115, 120, and/or AP 130, to perform the steps, data transmissions, and data receptions illustrated in FIGS. 2-9. Computing device 1012 may include a controller 1025. The controller 1025 may be connected to a user interface control 1030, display 1036 and/or other elements as illustrated. Controller 1025 may include circuitry, such as for example one or more processors 1028 and one or more memory 1034 storing software 1040. The software 1040 may comprise, for example, one or more of the following software options: client software 165, user interface software, server software, etc.

Device 1012 may also include a battery 1050 or other power supply device, speaker 1053, and one or more antennae 1054. Device 1012 may include user interface circuitry, such as user interface control 1030. User interface control 1030 may include controllers or adapters, and other circuitry, configured to receive input from or provide output to a keypad, touch screen, voice interface—for example via microphone 1056, function keys, joystick, data glove, mouse and the like. The user interface circuitry and user interface software may be configured to facilitate user control of at least some functions of device 1012 though use of a display 1036. Display 1036 may be configured to display at least a portion of a user interface of device 1012. Additionally, the display may be configured to facilitate user control of at least some functions of the device (for example, display 1036 could be a touch screen).

Software 1040 may be stored within memory 1034 to provide instructions to processor 1028 such that when the instructions are executed, processor 1028, device 1012 and/or other components of device 1012 are caused to perform various functions or methods such as those described herein. The software may comprise machine executable instructions and data used by processor 1028 and other components of computing device 1012 may be stored in a storage facility such as memory 1034 and/or in hardware logic in an integrated circuit, ASIC, etc. Software may include both applications and operating system software, and may include code segments, instructions, applets, pre-compiled code, compiled code, computer programs, program modules, engines, program logic, and combinations thereof.

Memory 1034 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein (including the claims), a tangible or non-transitory machine-readable storage medium is a physical structure that may be touched by a human. A signal would not by itself constitute a tangible or non-transitory machine-readable storage medium, although other embodiments may include signals or ephemeral versions of instructions executable by one or more processors to carry out one or more of the operations described herein.

As used herein, processor 1028 (and any other processor or computer described herein) may include any of various types of processors whether used alone or in combination with executable instructions stored in a memory or other computer-readable storage medium. Processors should be understood to encompass any of various types of computing structures including, but not limited to, one or more microprocessors, special-purpose computer chips, field-programmable gate arrays (FPGAs), controllers, application-specific integrated circuits (ASICs), combinations of hardware/firmware/software, or other special or general-purpose processing circuitry.

As used in this application, the term ‘circuitry’ may refer to any of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present.

These examples of ‘circuitry’ apply to all uses of this term in this application, including in any claims. As an example, as used in this application, the term “circuitry” would also cover an implementation of merely a processor (or multiple processors) or portion of a processor and its (or their) accompanying software and/or firmware. The term “circuitry” would also cover, for example, a baseband integrated circuit or applications processor integrated circuit for a mobile phone or a similar integrated circuit in a server, a cellular network device, or other network device

Device 1012 or its various components may be mobile and be configured to receive, decode and process various types of transmissions including transmissions in Wi-Fi networks according to a wireless local area network (e.g., the IEEE 802.11 WLAN standards 802.11n, 802.11ac, etc.) and/or wireless metro area network (WMAN) standards (e.g., 802.16), through a specific one or more WLAN transceivers 1043, one or more WMAN transceivers 1041. Additionally or alternatively, device 1012 may be configured to receive, decode and process transmissions through various other transceivers, such as FM/AM Radio transceiver 1042, and telecommunications transceiver 1044 (e.g., cellular network receiver such as CDMA, GSM, 4G LTE, 5G, etc.).

Although the above description of FIG. 10 generally relates to a mobile device, other devices or systems may include the same or similar components and perform the same or similar functions and methods. For example, a computer communicating over a wired network connection (for example, PC 115 of FIG. 1) may include the components or a subset of the components described above, and may be configured to perform the same or similar functions as device 1012 and its components. Further access points as described herein may include the components, a subset of the components, or a multiple of the components (e.g., integrated in one or more servers) configured to perform the steps, described herein.

1-42. (canceled)

43. A method comprising:
assigning a user device to a network slice of a plurality of network slices;
determining, by a computing device, whether transmissions via the network slice satisfy a target;
based on determining whether transmissions via the network slice satisfy the target, adjusting, by the computing device, a token counter value associated with the network slice, wherein adjusting the token counter value is based on a previous token counter value associated with the network slice;
based on the adjusted token counter value, determining a weight associated with the user device;
allocating, to the user device and based on the weight associated with the user device, transmission resources; and
transmitting, to the user device and using the allocated transmission resources, one or more network packets.

44. The method of claim 43, wherein determining whether transmissions via the network slice satisfy the target comprises determining that transmissions via the network slice satisfy the target, and wherein adjusting the token counter value associated with the network slice comprises decreasing the token counter value associated with the network slice or increasing the token counter value associated with the network slice.

45. The method of claim 44, wherein decreasing the token counter value associated with the network slice comprises decreasing the token counter value to a predetermined low token counter value, and wherein increasing the token counter value associated with the network slice comprises increasing the token counter value to a predetermined high token counter value.

46. The method of claim 43, further comprising:
receiving, from a service data adaptation protocol (SDAP) layer, a scheduling parameter, wherein determining the weight associated with the user device comprises determining, based on the scheduling parameter received from the SDAP layer, the weight associated with the user device.

47. The method of claim 43, wherein determining whether transmissions via the network slice satisfy the target comprises determining that transmissions via the network slice do not satisfy the target, and wherein adjusting the token counter value associated with the network slice comprises increasing the token counter value associated with the network slice or decreasing the token counter value associated with the network slice.

48. The method of claim 47, wherein increasing the token counter value associated with the network slice comprises increasing the token counter value to a predetermined high token counter value, and wherein decreasing the token counter value associated with the network slice comprises decreasing the token counter value to a predetermined low token counter value.

49. The method of claim 48, further comprising:
based on a determination that a plurality of token counter values associated with the network slice match the predetermined high token counter value at least a threshold number of times or a determination that a plurality of token counter values associated with the network slice match the predetermined low token counter value at least a threshold number of times, adjusting a performance parameter associated with the network slice.

50. The method of claim 43, further comprising:
assigning a second user device to a second network slice of the plurality of network slices;
determining, by the computing device, whether transmissions via the second network slice satisfy a second target;
based on determining whether transmissions via the second network slice satisfy the second target, adjusting, by the computing device, a second token counter value associated with the second network slice;
based on the adjusted second token counter value, determining a second weight associated with the second user device; and
allocating, to the second user device and based on the second weight associated with the second user device, transmission resources.

51. The method of claim 43, further comprising: determining, by the computing device, a priority level associated with the user device, wherein determining the weight associated with the user device comprises determining, based on the priority level associated with the user device, the weight associated with the user device.

52. An apparatus comprising:
at least one processor; and
at least one memory including computer program code, wherein the at least one memory and the computer program code are configured to, with the at least one processor, cause the apparatus at least to perform:
assigning a user device to a network slice of a plurality of network slices;
determining whether transmissions via the network slice satisfy a target;
based on determining whether transmissions via the network slice satisfy the target, adjusting a token counter value associated with the network slice, wherein adjusting the token counter value is based on a previous token counter value associated with the network slice;
based on the adjusted token counter value, determining a weight associated with the user device;
allocating, to the user device and based on the weight associated with the user device, transmission resources; and
transmitting, to the user device and using the allocated transmission resources, one or more network packets.

53. The apparatus of claim 52, wherein determining whether transmissions via the network slice satisfy the target comprises determining that transmissions via the network slice satisfy the target, and wherein adjusting the token counter value associated with the network slice comprises decreasing the token counter value associated with the network slice or increasing the token counter value associated with the network slice.

54. The apparatus of claim 53, wherein decreasing the token counter value associated with the network slice comprises decreasing the token counter value to a predetermined low token counter value, and wherein increasing the token counter value associated with the network slice comprises increasing the token counter value to a predetermined high token counter value.

55. The apparatus of claim 52, wherein the at least one memory and the computer program code are configured to, with the at least one processor, cause the apparatus at least to perform: receiving, from a service data adaptation protocol (SDAP) layer, a scheduling parameter, wherein determining the weight associated with the user device comprises determining, based on the scheduling parameter received from the SDAP layer, the weight associated with the user device.

56. The apparatus of claim 52, wherein determining whether transmissions via the network slice satisfy the target comprises determining that transmissions via the network slice do not satisfy the target, and wherein adjusting the token counter value associated with the network slice comprises increasing the token counter value associated with the network slice or decreasing the token counter value associated with the network slice.

57. The apparatus of claim 56, wherein increasing the token counter value associated with the network slice comprises increasing the token counter value to a predetermined high token counter value, and wherein decreasing the token counter value associated with the network slice comprises decreasing the token counter value to a predetermined low token counter value.

58. The apparatus of claim 57, wherein the at least one memory and the computer program code are configured to, with the at least one processor, cause the apparatus at least to perform:
based on a determination that a plurality of token counter values associated with the network slice match the predetermined high token counter value at least a threshold number of times or a determination that a plurality of token counter values associated with the network slice match the predetermined low token counter value at least a threshold number of times, adjusting a performance parameter associated with the network slice.

59. The apparatus of claim 52, wherein the at least one memory and the computer program code are configured to, with the at least one processor, cause the apparatus at least to perform:
assigning a second user device to a second network slice of the plurality of network slices;
determining whether transmissions via the second network slice satisfy a second target;
based on determining whether transmissions via the second network slice satisfy the second target, adjusting a second token counter value associated with the second network slice;
based on the adjusted second token counter value, determining a second weight associated with the second user device; and
allocating, to the second user device and based on the second weight associated with the second user device, transmission resources.

60. The apparatus of claim 52, wherein the at least one memory and the computer program code are configured to, with the at least one processor, cause the apparatus at least to perform:
determining a priority level associated with the user device, wherein determining the weight associated with the user device comprises determining, based on the priority level associated with the user device, the weight associated with the user device.

61. The apparatus of claim 52, wherein the target comprises one or more of a bitrate target, a throughput target, a latency target, or a resource share target.

62. A computer-readable medium storing computer-readable instructions that, when executed by a computing device, cause the computing device at least to perform:
assigning a user device to a network slice of a plurality of network slices;
determining whether transmissions via the network slice satisfy a target;
based on determining whether transmissions via the network slice satisfy the target, adjusting a token counter value associated with the network slice, wherein adjusting the token counter value is based on a previous token counter value associated with the network slice;
based on the adjusted token counter value, determining a weight associated with the user device;
allocating, to the user device and based on the weight associated with the user device, transmission resources; and
transmitting, to the user device and using the allocated transmission resources, one or more network packets.
